(19) United States
(12) Patent Application Publication
(10) Pub. No.: US 2026/0058444 A1
(43) Pub. Date: Feb. 26, 2026

(54) POWER DISTRIBUTION SYSTEM

(71) Applicant: Controllable Currents LLC, Maple Valley, WA (US)

(72) Inventor: Ron McDowell, Maple Valley, WA (US)

(21) Appl. No.: 18/811,076

(22) Filed: Aug. 21, 2024

(51) Int. Cl. H02B 1/20; H02B 1/18

(52) U.S. Cl. CPC H02B 1/20; H02B 1/18

(57) ABSTRACT

A power distribution system capable of providing power system diagnostics is provided. The power distribution system includes a busbar, bolts, fuses, electrical connectors, and a circuit board including a microcontroller that is connected compactly to provide diagnostics for the power distribution system. The power distribution system provides the ability to monitor individual batteries and connected circuits to determine battery performance and state as well as load monitoring for attached circuits. The power distribution system provides total power system diagnostics without the need for a vendor-specific ecosystem.

### TECHNICAL FIELD

The present invention generally relates to power distribution systems, and more particularly, the present invention relates to an intelligent DC fused power distribution system that integrates a high-density busbar, multi-channel fusing system, and optional common busbar (ground bar) with a microcontroller to provide full diagnostics for the power distribution system.

### BACKGROUND

Generally, power distribution systems comprise a busbar that incorporates DC connections, distribution, fusing, battery monitoring, and/or battery management. The power distribution systems are useful in many applications that involve electrical power distribution and/or battery management including but not limited to marine applications, gasoline engines, building power supply, recreational vehicle environments, recreational equipment, power plants, mobile heavy equipment, server room, battery backup, off-grid power systems, and so on.

Existing power distribution systems do not evaluate if the connections to the fuse are proper. Connections may be loose, corroded, or have poorly crimped terminals thereby leading to improper functioning of the power distribution system. Further, the typical current monitoring consists of a single shunt monitoring the entire battery bank. This only provides course data like a gas gauge for the battery level. Further, most power distribution systems are not ignition-protected against operation in a flammable gasoline engine compartment. Thus, many existing power distribution systems are ineffective in challenging environments such as marine applications.

Various solutions exist in the prior art that attempt to solve the drawbacks/disadvantages of the existing power distribution systems. For instance, the Victron Lynx Distributor system from Victron Energy B.V. is a single shunt, power feed, and power distributor. Victron Lynx Distributor system is modular and may only monitor total power between power feeds and distributors and monitor for blown fuses. Further, the fuse selection of the Victron Lynx Distributor system does not offer ignition protection.

The existing solutions related to power distribution systems require all the devices/components of the power distribution systems that are providing/extracting power to communicate (talk) to each other on a proprietary ecosystem to provide the same level of diagnostics. Further, the existing solutions related to power distribution systems are ineffective and inefficient, have design flaws, are unsuitable for use in challenging environments, and provide limited/no diagnostics.

Considering the foregoing, there is a need for an intelligent power distribution system that eliminates the disadvantages of the prior art by integrating a high-density busbar, multi-channel fusing system, and ground bar along with a microcontroller to provide full diagnostics for the power distribution system.

### SUMMARY

It is an objective of the present invention to provide a power distribution system that is compatible with challenging environments such as marine applications and recreational vehicle applications.

It is an objective of the present invention to provide a power distribution system that provides total power system diagnostics without the need for a vendor-specific ecosystem.

It is another objective of the present invention to provide a power distribution system that may detect a blown fuse.

It is another objective of the present invention to provide a power distribution system capable of monitoring the temperature of the busbar and electrical connector to detect any loose or corroded terminals.

It is an objective of the present invention to provide a power distribution system compatible with standard transportation battery voltages (12V, 24V, 32V, 36, & 48V DC supply).

It is an objective of the present invention to provide a power distribution system that allows for paralleling multiple fuses of identical size for current capacity beyond a single fuse.

It is an objective of the present invention to provide a power distribution system that may diagnose battery bank issues by splitting the battery bank and feeding/monitoring the busbar on multiple fuse channels.

It is another objective of the present invention to provide a power distribution system comprising fuse channels that may be linked together in software for comparison diagnostics such as detecting when redundant alternators are charging at different rates.

Embodiments of the present invention discloses a power distribution system comprising a busbar having a plurality of through holes; a plurality of bolts extending through the plurality of through holes of the busbar and electrically insulated from the busbar. Each through hole of the busbar is configured to receive a corresponding bolt selected from the plurality of bolts. The power distribution system further comprising a plurality of fuses, wherein each fuse is configured for holding a fusible link and configured to engage with a corresponding bolt selected from the plurality of bolts. The power distribution system further includes a plurality of electrical connectors configured for providing electrical connection to the plurality of fuses and the plurality of electrical components, wherein each electrical connector is further configured to engage with a corresponding bolt selected from the plurality of bolts. The power distribution system further includes a circuit board electrically connected to the plurality of bolts, wherein the circuit board includes a microcontroller to provide diagnostics for the power distribution system.

In another embodiment, the fuse is selected from a group of fuses comprising of: Marine Rated Battery Fuse (MRBF), or ZCASE thru bolt style fuses.

In another embodiment, the electrical connector is a wire crimp terminal connector or busbar.

In another embodiment, at least one fuse is replaceable by a shunt for increased measurement accuracy.

In another embodiment, the power distribution system further comprises a temperature monitored common busbar that is configured to provide a monitored return path for a common side of power distribution. By monitoring the busbar temperature, poor electrical connections between the busbar and the crimp terminal and the wire crimp quality can be identified in the form of excess heat.

In another embodiment, the power distribution system further comprises a bottom plate that encapsulates and/or holds various parts and components of the power distribution system, and the circuit board is sandwiched between the back of the busbar and/or the thin insulator plate and the bottom plate.

In another embodiment, the thickness of the busbar is variable for multiple current ratings depending on the needs of the user.

In another embodiment, the multiple busbars are linked together for the expansion of capacity forming a modular power distribution and monitoring system.

In another embodiment, the exposed part of the bolt is fused protecting from catastrophic failure due to accidental shorts.

In another embodiment, the power distribution system further comprises an insulator that insulates the bolt from the busbar, a thin insulator plate that isolates the circuit board from the busbar, and a fuse alignment guide that is configured to align the fuse in the center of the through hole and insulate the busbar from the bolt.

In another embodiment, the multiple fuses are linked together along with multiple bolts in series and/or parallel to define a combined fuse node.

In another embodiment, the microcontroller is programmable to allow the microcontroller to monitor the plurality of fuses, collect data, and communicate to upstream devices having multiple communication protocols.

In another embodiment, the power distribution system further comprises a washer and a hex nut that secures the mounting of the fuse and the electrical connector on the bolt.

In another embodiment, the fuse is installed/connected to the bolt of the power distribution system in a variety of configurations selected from a group comprising of: either alone as a stand-alone unit, by using a conductive spacer and jumper, and/or by using a fuse block/fuse holder.

In another embodiment, the microcontroller measures the temperature of the busbar and bolt to determine the quality of electrical connections.

In another embodiment, the microcontroller determines the current flowing through each fuse by using the predefined internal resistance of the fusible link of the fuse and then generating a small differential voltage representing the magnitude of the current flowing bi-directionally through each fuse.

In another embodiment, the microcontroller is configured to monitor system busbar voltage.

In another embodiment, the microcontroller is configured to monitor power of each fused circuit.

In another embodiment, the microcontroller is configured to monitor for a blown fuse (150) for each fused circuit.

In another embodiment, the microcontroller is configured to monitor connected device cycle count/rate such as but not limited to refrigerator or pump cycle start/stop frequency of each fused circuit.

In another embodiment, the microcontroller is configured to determine connected battery state of charge.

In another embodiment, the microcontroller is configured to allow paralleling of identically sized fused circuits to increase capacity beyond that of a single fuse.

In another embodiment, the microcontroller is configured to diagnose battery bank status by splitting the bank into multiple fused channels so each sub-bank can be compared to its partner to aid in diagnosing a weak or failing sub-bank channel during charging and discharging.

These and other features and advantages of the present invention will become apparent from the detailed description below, in light of the accompanying drawings.

### BRIEF DESCRIPTION OF THE DRAWINGS

FIGS. 1-5 illustrate various views of a power distribution system, according to an embodiment of the invention.

FIG. 6 illustrates a sectional view of a power distribution system of FIG. 3, according to an embodiment of the invention.

FIG. 7 illustrates a schematic diagram of a typical power distribution system of FIGS. 1-5 connected to various electrical components.

FIG. 8 illustrates a perspective view of a circuit board of the power distribution system of FIGS. 1-5.

FIG. 9 illustrates a perspective view of a known fuse of the first type of the power distribution system of FIGS. 1-5.

FIG. 10 illustrates a perspective view of an insulator of the known fuse of FIG. 9.

FIG. 11 illustrates a perspective view of the known fuse of the first type covered with the insulator.

FIG. 12 illustrates a perspective view of a single known fuse of the first type positioned in a fuse block/fuse holder.

FIG. 13 illustrates a perspective view of two known fuses of the first type positioned in a fuse block/fuse holder.

FIG. 14 illustrates a perspective view of the known fuse of a second type.

FIG. 15 illustrates a perspective view of the known fuse of the second type positioned in the fuse block/fuse holder.

### DETAILED DESCRIPTION

Before describing the present invention in detail, it should be observed that the present invention utilizes a combination of components or processes, which constitutes a power distribution system. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which may be embodied in various forms. Therefore, specific component-level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items.

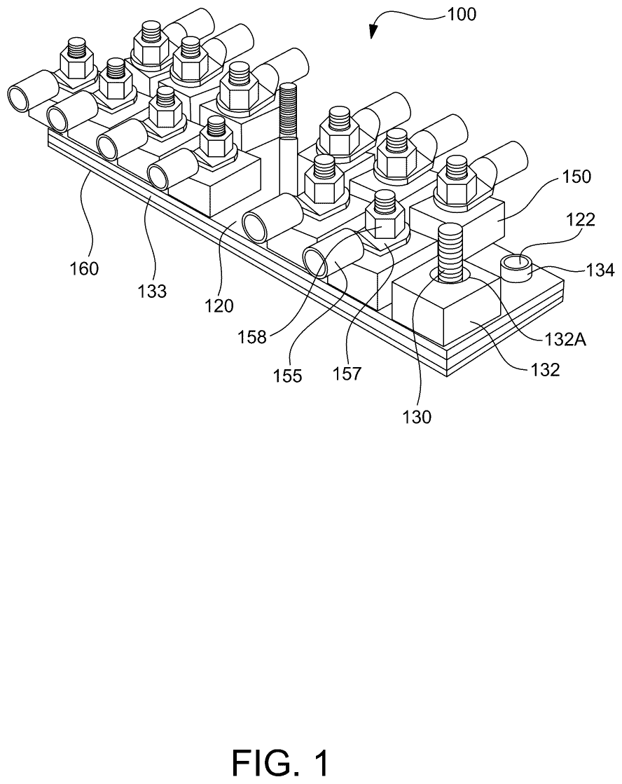

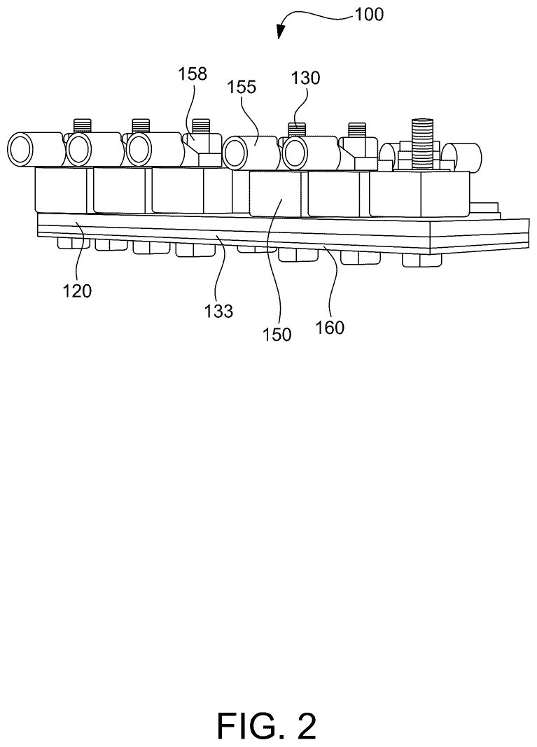

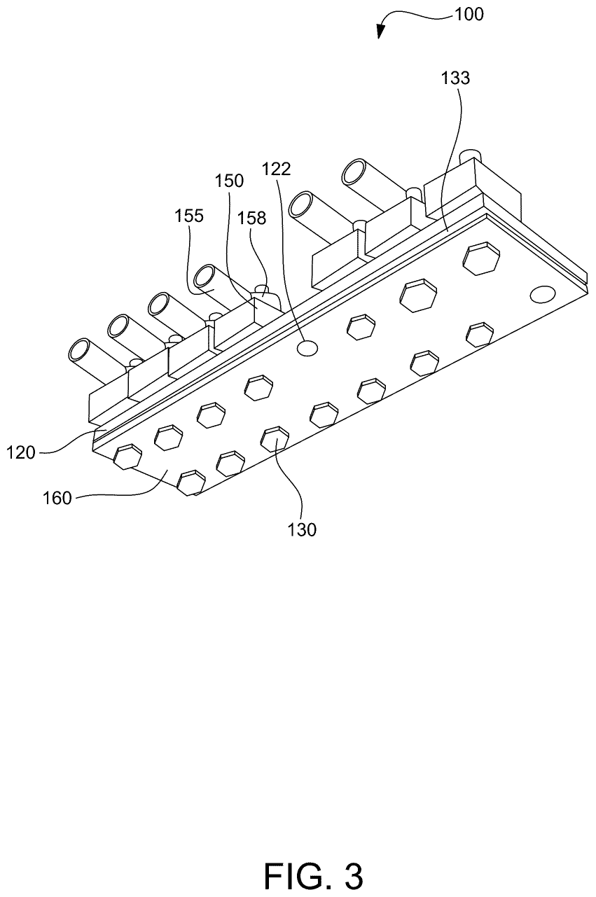

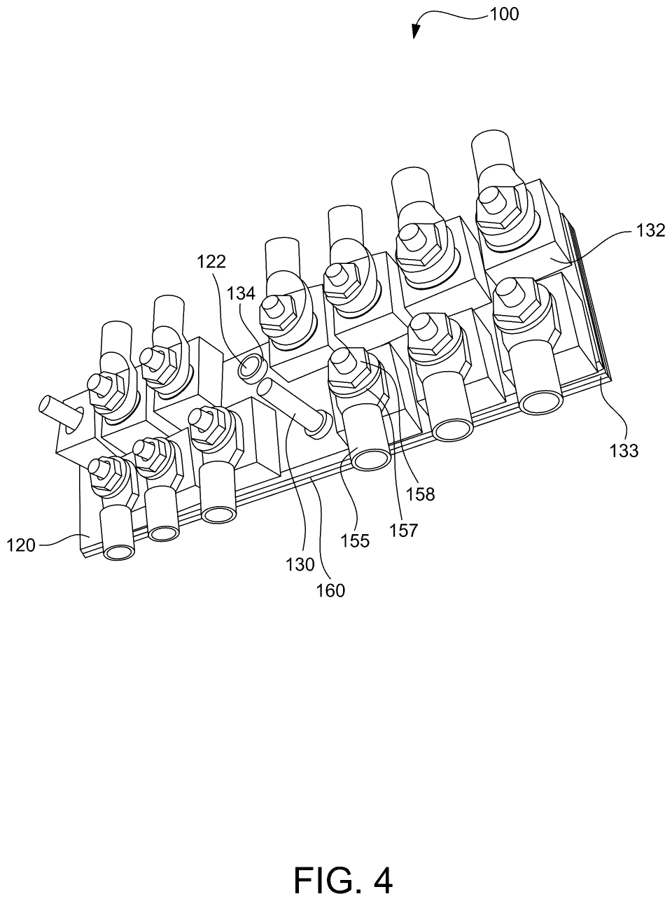

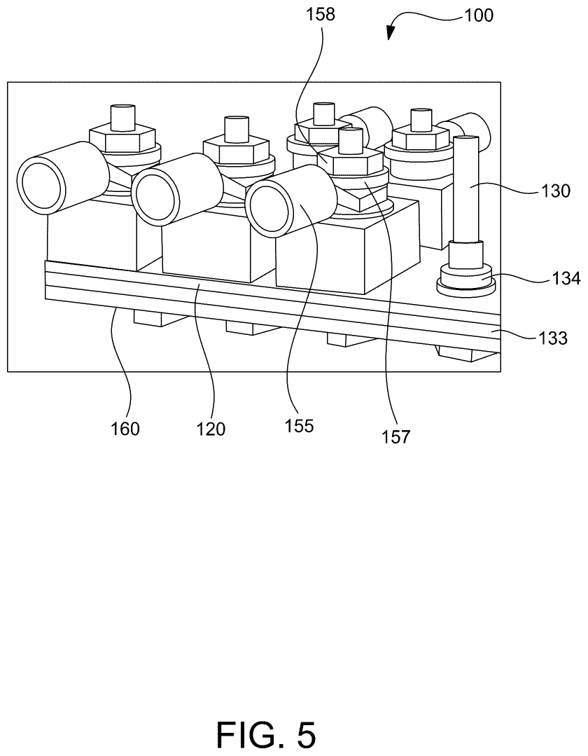

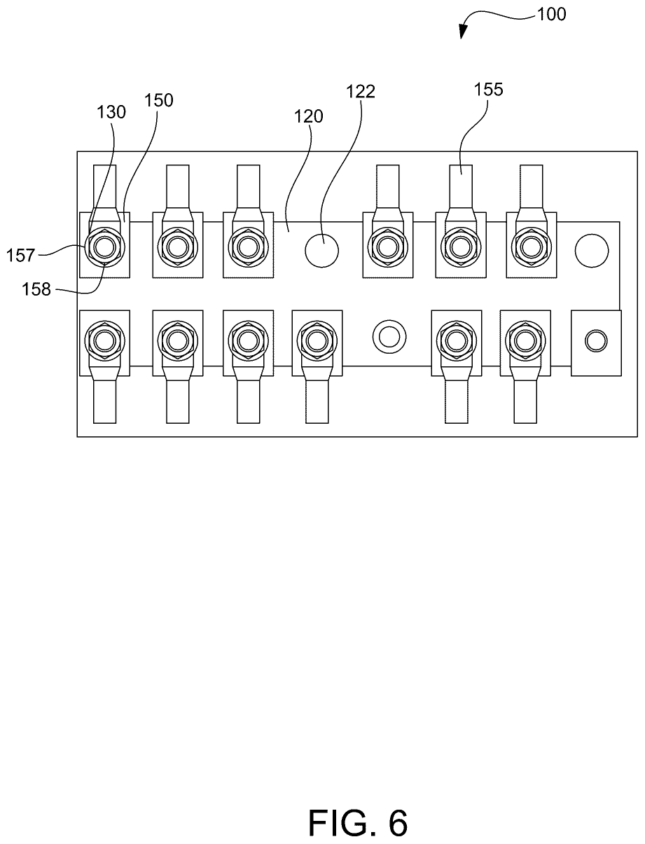

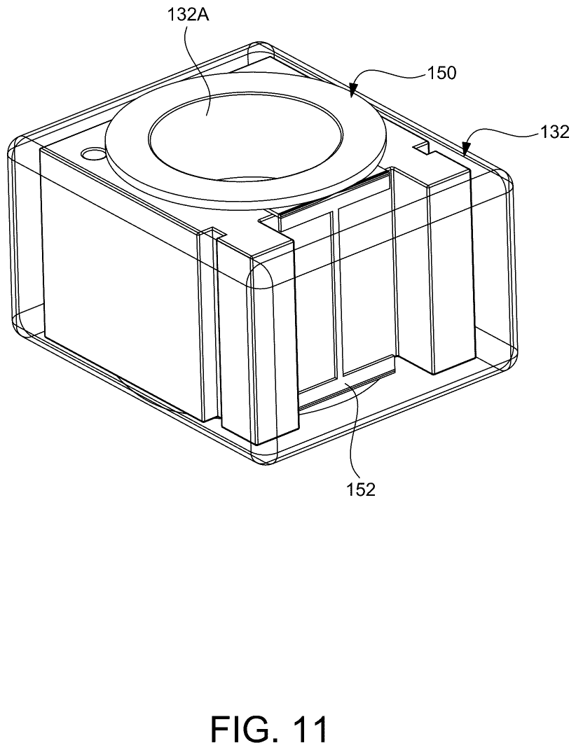

The power distribution system of various embodiments of the present invention will now be described with reference to the accompanying drawings, particularly FIGS. 1-15.

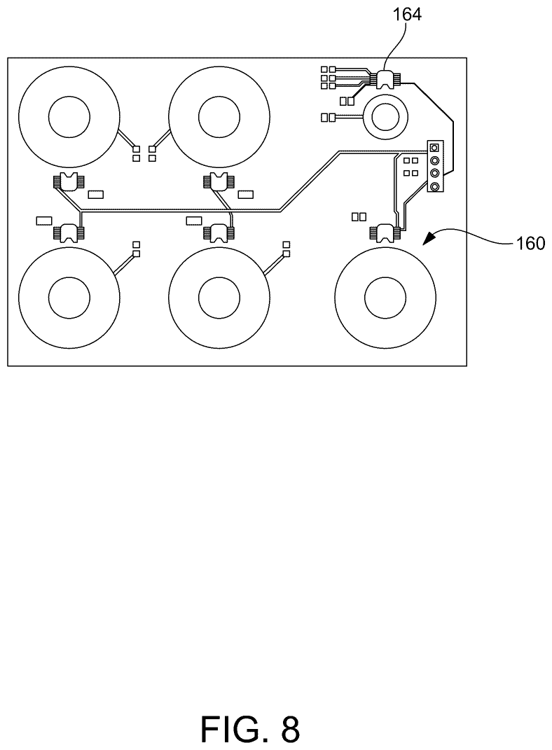

Referring initially to FIGS. 1-6 that illustrate various views of a power distribution system 100, according to an embodiment of the invention. The power distribution system 100 is an intelligent DC (direct current) fused power distribution system that integrates a high-density busbar 120, a multi-channel fusing system comprising a plurality of fuses 150, a plurality of bolts 130, a plurality of electrical connectors 155, and an optional common busbar 170 (ground bar) (not shown in figures) with a circuit board 160 that includes a microcontroller 164 (FIG. 8) to provide full diagnostics for the power distribution system 100, the entirety of which will be described in greater detail in below description.

In an embodiment (not shown in figures), the power distribution system 100 includes a bottom plate 102 (not shown in figures) that encapsulates and/or holds various parts and components of the power distribution system 100. The bottom plate 102 (not shown in figures) further provides a base for mounting/assembly of various parts and components such as but not limited to: a busbar 120, a plurality of bolts 130, a circuit board 160, and so on. The busbar 120 has a predefined thickness and is made of high conductivity metal such as but not limited to: copper and so on and the busbar 120 is configured to distribute power to each fused circuit. The thickness of the busbar 120 may be varied for multiple current ratings depending on the needs of the user. Further, the multiple busbars 120 may be linked together for the expansion of capacity. The circuit board 160 is sandwiched (positioned between) between the back of the busbar 120 and/or a thin insulator plate 133 and the bottom plate 102 (not shown in figures).

As seen in FIGS. 1-6, the busbar 120 includes a plurality of through holes 122, wherein each through hole 122 is configured to receive a bolt 130 selected from the plurality of bolts 130. The bolt 130 is configured to clamp the wire crimp terminal connector 155 to the fuse 150. The bolt 130 also carries voltage and temperature from the wire crimp terminal connector 155 to the circuit board 160. The bolt 130 carries a minimal (few) microampere of current. The exposed part of the bolt 130 is fused protecting from accidental shorts.

Referring to FIGS. 1-6, the power distribution system 100 further comprises an insulator 132 that comprises a hole 132A for passage of the bolt 130, a thin insulator plate 133, and a fuse alignment guide 134. The thin insulator plate 133 and the insulator 132 insulates the bolt 130 from the busbar 120, and the thin insulator plate 133 isolates the circuit board 160 from the busbar 120. The fuse alignment guide 134 is configured to align the fuse 150 in the centre of the through hole 122 and insulate the bolt 130 from the busbar 120. The temperature of the busbar 120 and/or bolt 130 is measured to determine if the electrical connections are functioning properly. The bolt 130 extends from the circuit board 160 passing through the thin insulator plate 133 and the busbar 120 such that the head of bolt 130 is positioned downward (in contact with the underside) of the circuit board 160 and a portion of the bolt 130 protrudes (exposed) from the top of the busbar 120 for mounting of the fuse 150 and the electrical connectors 155 as seen in FIGS. 1-6. A washer 157 and a hex nut 158 secure the mounting of the fuse 150 and the electrical connector 155 on the bolt 130. As seen in FIGS. 1-6, a few components of the power distribution system 100 are not shown for the sake of simplicity and ease of understanding. For instance, as seen in FIG. 1, a through hole 122 shown on the right side does not illustrate the bolt 130, the fuse 150, and the hex nut 158, etc to clearly illustrate the fuse alignment guide 134 for ease of understanding. Further, the insulator 132 and/or thin insulator plate 133 is made of non-conductive material such as but not limited to: plastic, rubber, and so on.

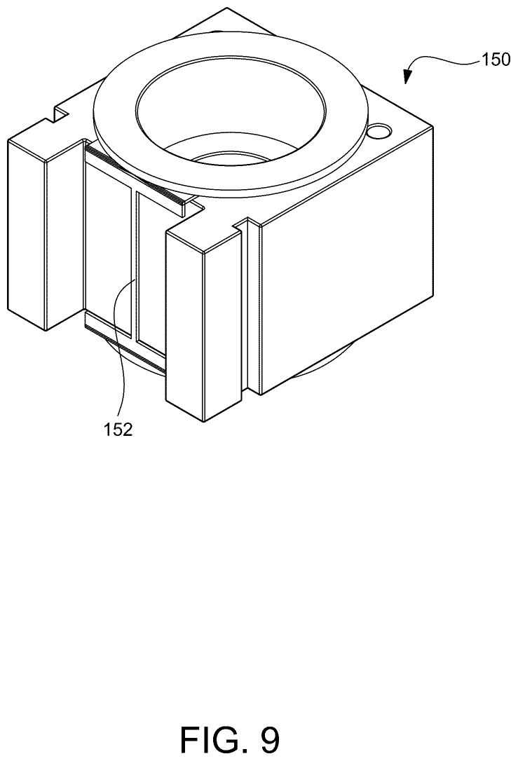

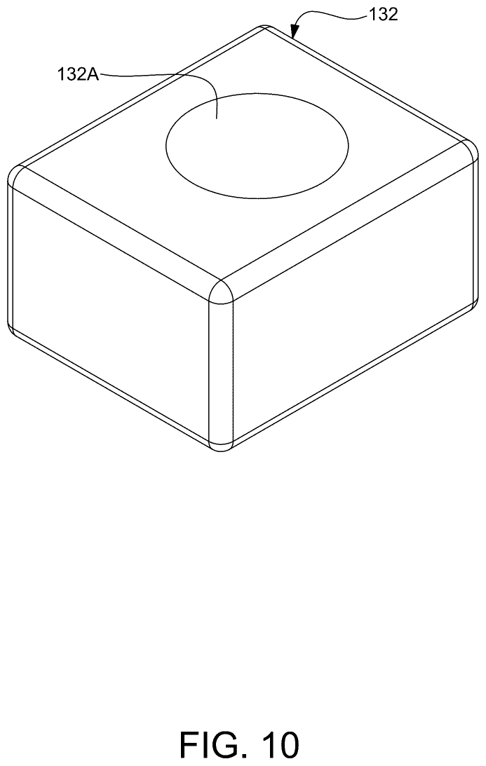

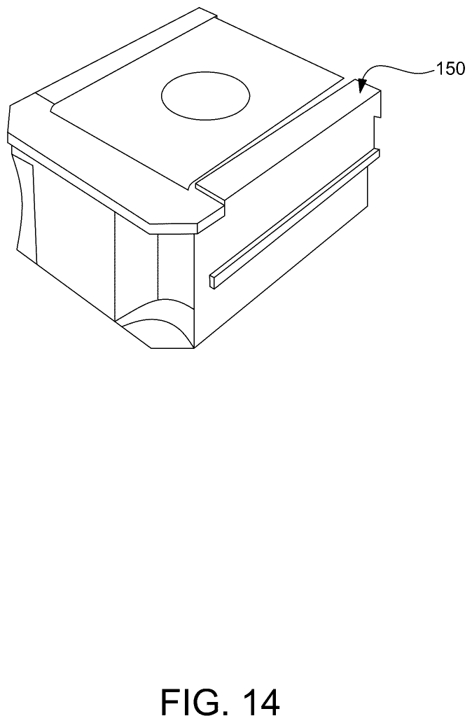

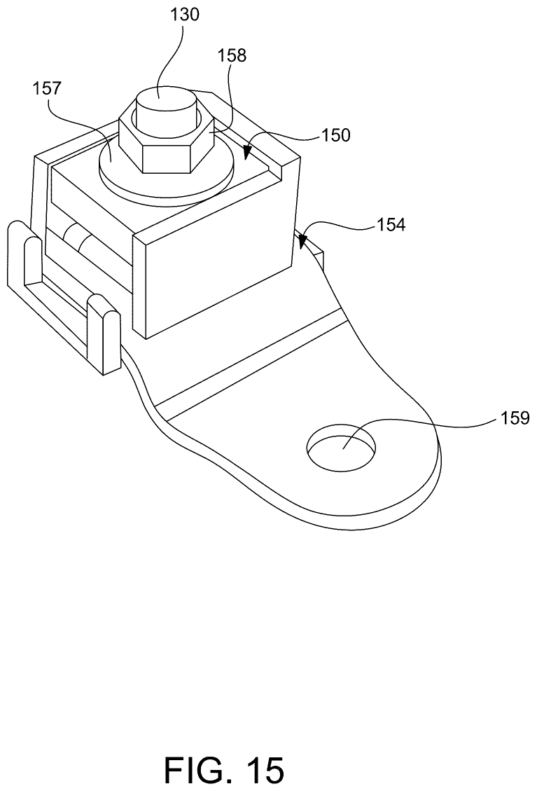

Each bolt 130 is further configured to engage with a fuse 150, wherein the fuse 150 is configured for holding a fusible link 152 (FIGS. 10-12). The fuse 150 is configured to protect each circuit from overcurrent conditions. The fuse 150 has a low resistance that may be leveraged by the circuit board 160 to measure current flow bi-directionally. The fuse 150 is known in the prior art and sold by various merchandises such as but not limited to: Bussmann MRBF fuse as seen in FIGS. 9-13 and Littelfuse Z case Minimal Footprint Bolt Down Fuse as seen in FIGS. 14-15. The fuse 150 may have any type/design with a through hole that may be bolted using the bolt 130 such as but not limited to: Marine Rated Battery Fuse (MRBF), Bolt Down Fuse, and so on. Further, the Exposed (top) part of the bolt 130 is fuse protected from accidental short circuits. The fusible link 152 of the fuse 150 has a predefined internal resistance that is used to determine the current flowing through each fuse 150 and generating a small differential voltage representing the magnitude of current flowing through each fuse 150. Circuits of multiple fuses 150 may be linked (connected) together along with multiple bolts 130 in series and/or parallel to define a multi-channel fuse node. The number of bolts 130 and the number of fuses 150 are arbitrary and may be more than two in number such as but not limited to: two, four, six, eight, sixteen, and so on.

In another embodiment (not shown in figures), the fuse 150 is replaceable with a shunt (a metal alloy of fixed resistance) of similar size for increased measurement accuracy of current. It may be achieved by using the full range of analog to digital converters and reducing variability of resistance as fuses become hot when operating near their rated current limit. This would normally be used for a battery connection(s) where the battery is fused on or near the battery.

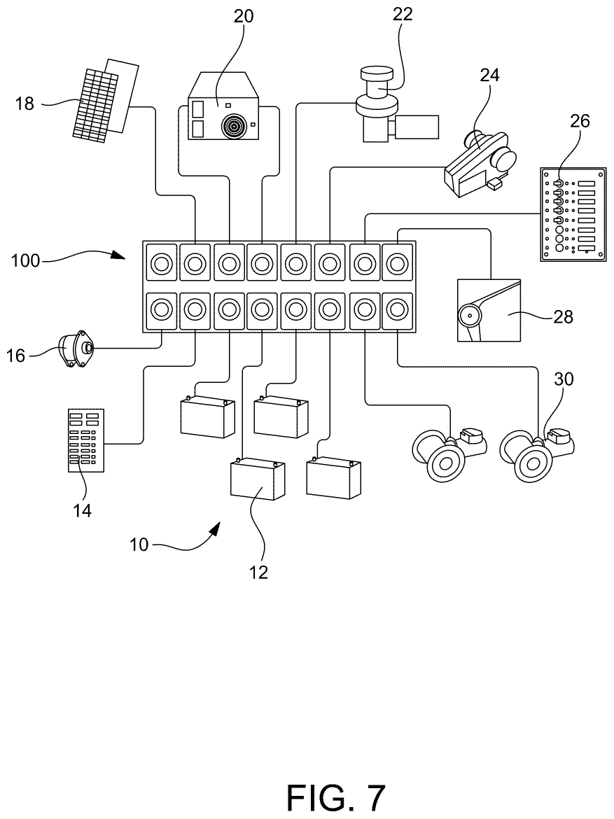

An electrical connector 155 is configured to provide an electrical connection to the fuse 150. The electrical connector 155 is further configured to engage with a corresponding bolt 130 selected from the plurality of bolts 130. In an embodiment as seen in FIGS. 1-6, the electrical connector 155 is a wire crimp terminal connector 155 that is electrically connected to an electrical component as seen in FIG. 7.

In another embodiment (not shown in figures), the power distribution system 100 may not include a circuit board 160 to enable the busbar 120 to function only as a passive fused (non-monitored) busbar 120, providing a configuration that allows for a simpler functionality of the busbar 120.

The common busbar 170 (not shown in the figures) is configured to provide a return path for a common side of power distribution. The common busbar 170 (not shown in the figures) is optional and may be removed depending on the requirements of the user. The temperature of the common busbar 170 (not shown in the figures) is also measured to evaluate the quality of the electrical connections.

In another embodiment (not shown in figures), a jumper bar (not shown in the figures) may comprise a hole (not shown in the figures) at either end that may combine (tie) two or more busbars 120 through (using) their respective through holes 122 and/or complementary accessories (not shown in figures) together using either: two fuses, two conductive spacers, or one of each depending on where electric power is being fed from. The jumper bar (not shown in the figures) may further be used instead of the wire crimp terminal connector 155. Alternatively, a wire (not shown in figures) could be used with a wire crimp terminal connector 155 on either ends to tie (combine) the two or more busbars 120 through (using) their respective through holes 122 and/or complementary accessories (not shown in figures) together using either: two fuses, two conductive spacers, or one of each depending on where electric power is being fed from. Complimentary accessories (not shown in figures) may include but are not limited to fuse block/fuse holder 154 (FIG. 9-15) of different types, a total system shunt, etc. Further, two or more common busbars 170 (not shown in the figures) can be combined (tied) together with a jumper bar (not shown in the figures) and/or a wire (not shown in the figures).

Referring to FIG. 7, the power distribution system 100 is primarily useful for distributing electric power and/or monitoring and/or diagnosis of the various electrical components 10 such as but not limited to: battery bank 12, an engine room panel 14, an alternator 16, solar panels 18, an inverter/charger 20, an electric winch 22, a windlass 24, an accessory panel 26, a crab pot puller 28, bow thrusters 30, and so on. Other devices may also be connected from other platforms such as but not limited to recreational vehicle (RV) electric jacks, off road vehicle winch, dump trailer hydraulic pump, ambulance electronics, and so on.

Referring to FIG. 8, a circuit board 160 is shown which is electrically connected to the plurality of bolts 130. The circuit board 160 includes a microcontroller 164 to provide diagnostics for the power distribution system 100. The circuit board 160 is a printed circuit board (PCB) and includes measurement chips, and associated control circuitry that may include components such as but not limited to: rectifiers, transformers, resistors, capacitors, potentiometer, transistors, diodes, Integrated circuits, microchips, thermistor, and other sensors and so on. The circuit board 160 is configured to provide all measurements to the upstream control system via multiple optional communication paths. Each fuse channel may monitor temperature, voltage, bi-directional current, power, Amp Hours, kilowatt hours, battery state of charge, attached device cycle rate, & cycle count, and blown fuse detection. When channels are paralleled, then each paralleled group may consolidate (combine) measurements. The circuit board 160 and the associated control circuitry do not affect the working of the fuse 150. The microcontroller 164 is programmable to allow the microcontroller 164 to monitor the fuses 150, collect data, and communicate to upstream devices having multiple communication protocols.

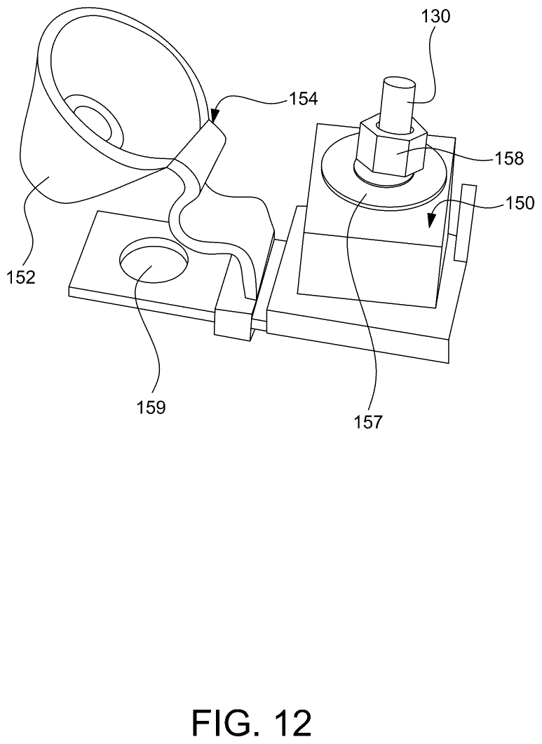

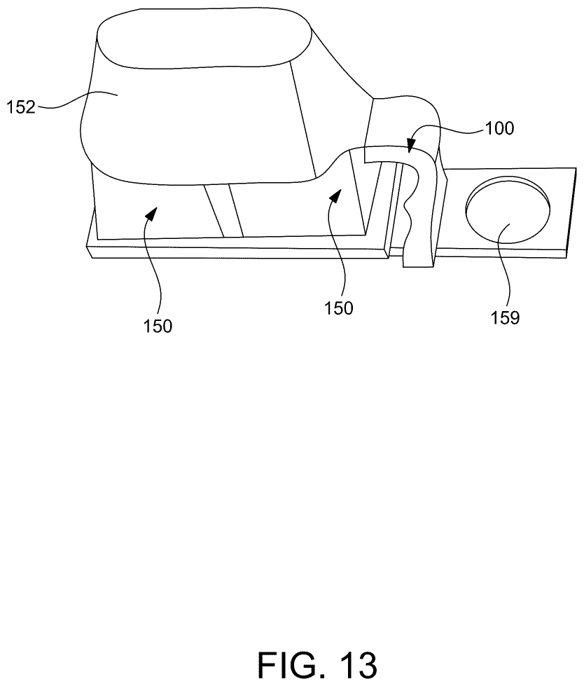

Referring to FIGS. 9-13, the fuse 150 of a first type (MRBF type) is shown that is supplied by Bussmann and is available on various e-commerce websites. The fuse 150 of MRBF type may be installed/connected to the power distribution system 100 in a variety of configurations/manners: either alone as a stand-alone unit (FIG. 9) or by using a conductive spacer and jumper (not shown in figures), and/or using fuse block/fuse holder 154 (FIGS. 12-13). In various embodiments, as seen in FIGS. 12-13, the fuse 150 of MRBF (Marine Rated Battery Fuse) type is positioned in a fuse block/fuse holder 154. Further, the fuse block/fuse holder 154 includes an insulation cap 156, washer 157, hex nut 158, and an installation hole 159 to support the installation of the fuse 150. As seen in FIG. 12, a single fuse 150 is positioned in the fuse block/fuse holder 154. Wherein in the embodiment as seen in the FIG. 13, two fuses 150 are positioned in a single fuse block/fuse holder 154.

Referring to FIGS. 14-15, the fuse 150 of the second type (ZCASE type) is shown that is supplied by Littelfuse and is available on various e-commerce websites. The fuse 150 of ZCASE type may be installed/connected to the bolt 130 of the power distribution system 100 in a variety of configurations selected from a group comprising: either alone as a stand-alone unit (FIG. 14) or by using a conductive spacer and jumper (not shown in figures), and/or using a fuse block/fuse holder 154 (FIG. 15).

The power distribution system 100 according to various embodiments of the present invention offers various advantages/solutions compared to the prior art. The power distribution system 100 is configured to detect a blown fuse 150. The power distribution system 100 is configured such that the power distribution system 100 treats each fuse 150 as a current monitoring shunt. The power distribution system 100 is more advantageous such that the power distribution system 100 may diagnose battery bank issues, totalize power usage per fuse channel, count end device (electrical components 10) power cycles (pumps, refrigerators, etc.). Further, each fuse channel may measure current in both directions. Further, two or more fuse channels may be combined if additional current requirements exceed the fuse limit of the fuse 150. The power distribution system 100 may also monitor the temperature of the busbar 120 and electrical connector 155 to detect the loose or corroded terminals. The power distribution system 100 has the added advantage that the power distribution system 100 is compatible with standard transportation battery voltages (12V, 24V, 32V, 36, & 48V DC supply). The power distribution system 100 may utilize Ignition Protected 10,000@12VDC Ampere Interrupting Capacity (AIC) Marine Rated Battery Fuse (MRBF). When separating a large battery bank into multiple fused channels, the power distribution system 100 allows diagnostics of an unhealthy bank segment such as a single channel charging/discharging at a different rate or a continuous draw of current event after fully charged. The power distribution system 100 further allows for paralleling multiple fuses 150 of identical size for current capacity beyond a single fuse. When monitored, the paralleled fuses 150 may act as a single channel combining some measurement values in addition to single channel measurements. Each fuse channel or paralleled fuse channel may operate as a dedicated power consumer, power distributor, or bi-directional in the case of electrical components 10 such as but not limited to batteries, inverter/chargers, supercapacitors, and so on. Thus, the power distribution system 100 provides total power system diagnostics without the need for a vendor-specific ecosystem. The power distribution system 100 may diagnose battery bank issues by splitting the battery bank and feeding busbar 120 on multiple fuse channels. The fuse channels may be linked together in software for comparison diagnostics such as detecting when redundant alternators are charging at different rates.

The microcontroller 164 of the power distribution system 100 according to various embodiments of the present invention offers various advantages/solutions compared to the prior art. The microcontroller 164 is configured to monitor system busbar 120 voltage. Further, the microcontroller 164 is configured to monitor power of each fused circuit. The microcontroller 164 is configured to monitor for a blown fuse 150 for each fused circuit. Further, the microcontroller 164 is configured to monitor connected device cycle count/rate such as but not limited to refrigerator or pump cycle start/stop frequency of each fused circuit. Further, the microcontroller 164 is configured to determine connected battery state of charge. Further, the microcontroller 164 is configured to allow paralleling of identically sized fused circuits to increase capacity beyond that of a single fuse. Further, the microcontroller 164 is configured to diagnose battery bank status by splitting the bank into multiple fused channels so each sub-bank can be compared to its partner to aid in diagnosing a weak or failing sub-bank channel during charging and discharging. Although embodiments of the invention have been described in detail for purposes of illustration, various modifications, and enhancements may be made without departing from the spirit and scope of the invention.

What is claimed is:

1. A power distribution system (100), comprising:
a busbar (120) having a plurality of through holes (122);
a plurality of bolts (130) extending through the plurality of through holes (122) of the busbar (120) and electrically insulated from the busbar (120);
wherein each through hole (122) is configured to receive a corresponding bolt (130) selected from the plurality of bolts (130);
a plurality of fuses (150), wherein each fuse (150) is configured for holding a fusible link (152) and to engage with a corresponding bolt (130) selected from the plurality of bolts (130);
a plurality of electrical connectors (155) configured for providing electrical connection to the plurality of fuses (150) and a plurality of electrical components (10), wherein each electrical connector (155) is further configured to engage with a corresponding bolt (130) selected from the plurality of bolts (130); and
a circuit board (160) electrically connected to the plurality of bolts (130), wherein the circuit board (160) comprises at least a microcontroller (164) to provide diagnostics for the power distribution system (100).

2. The power distribution system (100) according to claim 1, wherein each of the plurality of fuses (150) is selected from a group of fuses consisting of a Marine Rated Battery Fuse (MRBF), ZCASE, or other thru bolt fuse.

3. The power distribution system (100) according to claim 1, wherein each of the plurality of electrical connectors (155) is a wire crimp terminal connector (155).

4. The power distribution system (100) according to claim 1, wherein at least one fuse (150) of the plurality of fuses (150) is replaceable by a shunt.

5. The power distribution system (100) according to claim 1 further comprising an optional temperature monitored common busbar (170) that is configured to provide a monitored return path for a common side of power distribution.

6. The power distribution system (100) according to claim 1 further comprising a bottom plate (102) that encapsulates and/or holds various parts and components of the power distribution system (100), and the circuit board (160) is sandwiched between the back of the busbar (120) and/or a insulator plate (133), and the bottom plate (102).

7. The power distribution system (100) according to claim 1, wherein the thickness of the busbar (120) is variable for multiple current ratings depending on the needs of the user.

8. The power distribution system (100) according to claim 1, wherein one or more busbars (120) are linked together for the expansion of capacity.

9. The power distribution system (100) according to claim 1, wherein the exposed part of the bolt (130) is fused protecting from catastrophic failure due to accidental shorts.

10. The power distribution system (100) according to claim 1 further comprising an insulator (132) that insulates the bolt (130) from the busbar (120), an insulator plate (133) that isolates the circuit board (160) from the busbar (120) and an insulated fuse alignment guide (134) that is configured to align the fuse (150) in the center of the through hole (122).

11. The power distribution system (100) according to claim 1, wherein multiple fuses (150) are linked together along with multiple bolts (130) in series and/or parallel to define a multi-fuse node.

12. The power distribution system (100) according to claim 1, wherein the microcontroller (164) is programmable to allow the microcontroller (164) to monitor the plurality of fuses (150), collect data, and communicate to upstream devices having multiple communication protocols.

13. The power distribution system (100) according to claim 1 further comprising a washer (157) and a hex nut (158) that secures the mounting of the fuse (150) and the electrical connector (155) on the bolt (130).

14. The power distribution system (100) according to claim 1, wherein the fuse (150) is connected to the bolt (130) of the power distribution system (100) in a configuration selected from a group comprising of: either alone as a stand-alone unit or combined, by using the conductive spacer and jumper to connect busbars together.

15. The power distribution system (100) according to claim 1, wherein the microcontroller (164) is configured to measure the temperature of the busbar (120) and the bolt (130) to determine the quality of electrical connections.

16. The power distribution system (100) according to claim 1, wherein the microcontroller (164) is configured to determine the current flowing through each fuse (150) by using the predefined internal resistance of the fusible link (152) of the fuse (150) and generating a small differential voltage representing the magnitude of current flowing bi-directionally through each fuse (150).

17. The circuit board (160) according to claim 1, wherein the microcontroller (164) is configured to monitor system busbar (120) voltage.

18. The circuit board (160) according to claim 1, wherein the microcontroller (164) is configured to monitor power of each fused circuit.

19. The circuit board (160) according to claim 1, wherein the microcontroller (164) is configured to monitor for a blown fuse (150) for each fused circuit.

20. The circuit board (160) according to claim 1, wherein the microcontroller (164) is configured to monitor connected device cycle count/rate such as but not limited to refrigerator or pump cycle start/stop frequency of each fused circuit.

21. The circuit board (160) according to claim 1, wherein the microcontroller (164) is configured to determine connected battery state of charge.

22. The circuit board (160) according to claim 1, wherein the microcontroller (164) is configured to allow paralleling of identically sized fused circuits to increase capacity beyond that of a single fuse (150).

23. The circuit board (160) according to claim 1, wherein the microcontroller (164) is configured to diagnose battery bank status by splitting the bank into multiple fused channels so each sub-bank can be compared to its partner to aid in diagnosing a weak or failing sub-bank channel during charging and discharging.
